(19) United States
(12) Patent Application Publication
(10) Pub. No.: US 2007/0204900 A1
(43) Pub. Date: Sep. 6, 2007

(54) Package structure for a solar chip

(76) Inventors: Li-Hung Lai, Taichung (TW); Li-Wen Lai, Hsinchu Hsien (TW); Kun-Fang Huang, Taichung (TW); Wen-Sheng Hsieh, Taichung (TW); Chia-Hung Lin, Taichung (TW); Li-Chieh Shih, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/365,621

(22) Filed: Mar. 2, 2006

(51) Int. Cl. H02N 6/00

(52) U.S. Cl. 136/246

(57) ABSTRACT

The present invention discloses a high-efficiency light-focusing package structure for a solar chip, which includes: a solar-chip sustaining substrate, a pair of positive-electrode and negative-electrode lead frames, and a covering. The covering may focus sunlight and also has an anti-reflective function to promote sunlight absorption. Further, the package structure for a solar chip of the present invention is low-cost and can be designed and assembled according to the size and shape required by a user.

### BACKGROUND OF THE INVENTION

1. Field of the Invention

The present invention relates to a light-focusing package structure for a solar chip, particularly to a package structure for a solar chip, which may be assembled in to an array of arbitrary shape.

2. Description of the Related Art

A solar cell utilizes photovoltaic effect to convert solar energy into electric energy. Refer to FIG. 1 for the structure of a conventional solar cell. The conventional solar cell 105 has an N-type-semiconductor layer 110, a P-type-semiconductor layer 112, an anti-reflective layer, and two electrodes 114 and 116. When photons enter into the solar cell 105, there are electrons-holes generated and diffusing across the junction between the N-type-semiconductor layer 110 and the P-type-semiconductor layer 112. Thus, a current is generated from the top electrode 114 and the bottom electrode 116. Generally, the solar energy absorbed by the solar cell 105 may be raised by increasing the light-receiving area or utilizing a light-focusing device, such as a lens structure. However, a large-area light-focusing element is hard to fabricate, and an arbitrary-size assemblage of solar cells is also hard to accomplish. Besides, the yield thereof is also hard to promote, and the cost thereof is thus raised. Therefore, developing an easy-fabrication and easy-assemblage light-focusing package structure for a solar chip is also one of the important subjects in the fields concerned.

### SUMMARY OF THE INVENTION

One of objects of the present invention is to provide a light-focusing package structure for a solar chip, which may be fabricated with LED fabrication process to simply the packaging process of a light-focusing solar cell.

Another one of objects of the present invention is to provide a package structure for a solar chip. The LED lead frame and epoxy encapsulation structure are used to package a solar chip in order to simplify the packaging process of a solar chip and implement the size-adjustability of a solar-cell assemblage.

To achieve the abovementioned objects, an embodiment of the present invention proposes a high-efficiency light-focusing package structure for a solar chip, which includes: a solar chip; a substrate supporting the solar chip; multitudes of wiring connection structures electrically coupled to the solar chip; and an covering encapsulating the solar chip, the substrate, and a portion of the wiring connection structures. Furthermore, the covering may focus sunlight and has an anti-reflective function to increase sunlight absorption.

### BRIEF DESCRIPTION OF THE DRAWINGS

FIG. 1 is a diagram schematically showing the structure of a conventional solar cell.

FIG. 2A and FIG. 2B are diagrams schematically showing the package structure for a solar chip according to a first embodiment of the present invention.

FIG. 3A and FIG. 3B are diagrams schematically showing the package structure for a solar chip according to a second embodiment of the present invention.

FIG. 4A and FIG. 4B are diagrams schematically showing the package structure for a solar chip according to a third embodiment of the present invention.

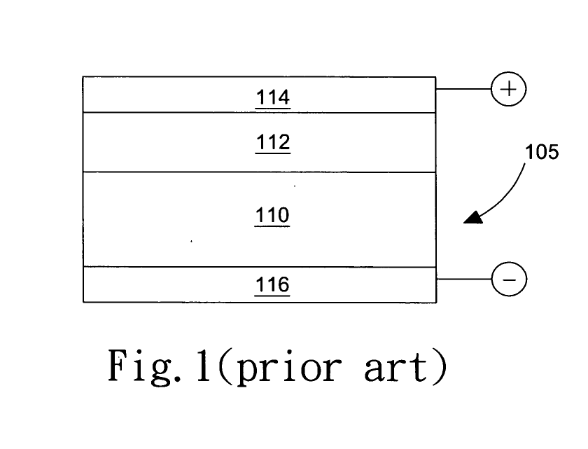

### DETAILED DESCRIPTION OF THE INVENTION

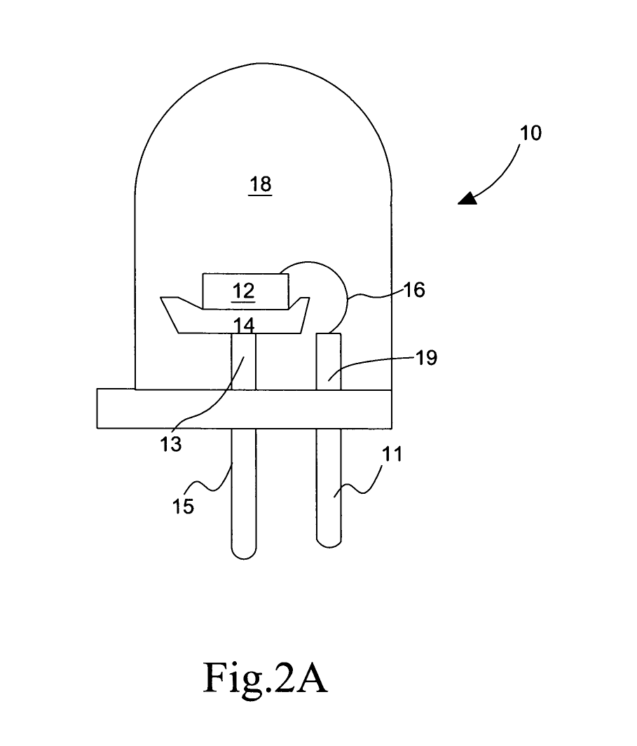

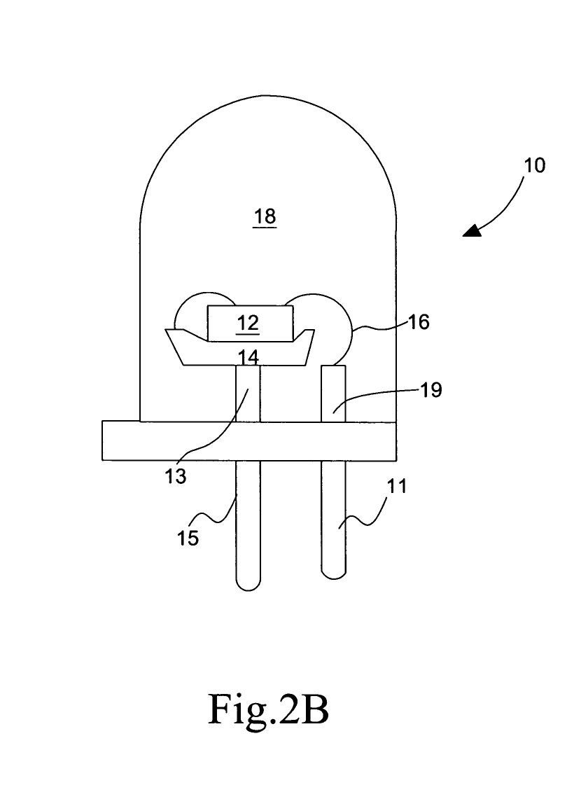

Refer to FIG. 2A a diagram schematically showing the package structure for a solar chip according to a first embodiment of the present invention. The dual In-line solar-chip package structure 10 includes: a solar chip 12, a substrate 14, multitudes of wiring connection structures 16, and a covering 18. In this embodiment, the substrate 14 is used to sustain or support the solar chip 12 and made of an electrically-conductive metal, such as copper or iron. The solar chip 12 may be a mono-crystalline-silicon solar chip, a polycrystalline-silicon solar chip, an amorphous-silicon solar chip, or a gallium arsenide solar chip. The solar chip 12 is affixed onto the surface of the substrate 14 via an appropriate method, such as via an adhesive layer (not shown in the drawing). However, in the present invention, the affixing method is not limited to using an adhesive layer. The solar chip 12 includes: at least one N-type-semiconductor layer, at least one P-type-semiconductor layer, an absorptive layer, and two electrodes. Those two electrodes are respectively electrically coupled to different wiring connection structures 16. In this embodiment, the positive electrode and the negative electrode are separately disposed at different sides of the solar chip 12, but, in another embodiment of the present invention, the positive electrode and the negative electrode may be disposed at same side of the solar chip 12, as shown in FIG. 2B. It is understood that the structure of the solar chip 12 is not limited to that mentioned above but may further include other structures, such as a glass substrate and a barrier layer. Inner leads 13 and 19 are respectively used to electrically connect the electrodes to external leads 15 and 11. The external leads 11 and 15 are configured to attach and electrically couple to an external structure (not shown in the drawing) and may also be used as power leads. The external leads 11 and 15 may be disposed at appropriate positions of the solar-chip package structure 10, such as the lateral side or the bottom of the solar chip 12. However, the present invention does not limit the external-lead position to those mentioned above.

The covering 18, such as an epoxy body, covers and protects the solar chip 12 and the inner leads 13 and 19, and may focus sunlight. In another embodiment, the covering 18 may also function as an anti-reflective layer and let more sunlight enter into the dual In-line solar-chip package structure 10. Due to the characteristic of its material, the covering 18 may be fabricated into various geometrical shapes to focus the sunlight from various directions. Thus, the dual In-line solar-chip package structure 10 may receive the sunlight coming from every direction even it is still at a fixed position. Therefore, the present invention may solve the problem that the solar panel consisting of assembled solar chips has to modify its orientation to follow the sun's track to increase incident sunlight. Besides, the dual In-line solar-chip package structure 10 can be fabricated with a common LED packaging process without any extra mold and machine. Further, the dual In-line solar-chip package structures 10 may be assembled in the same method as LED uses. Thus, the dual In-line solar-chip package structures 10 may be assembled into a solar-energy system of a desired size and geometry.

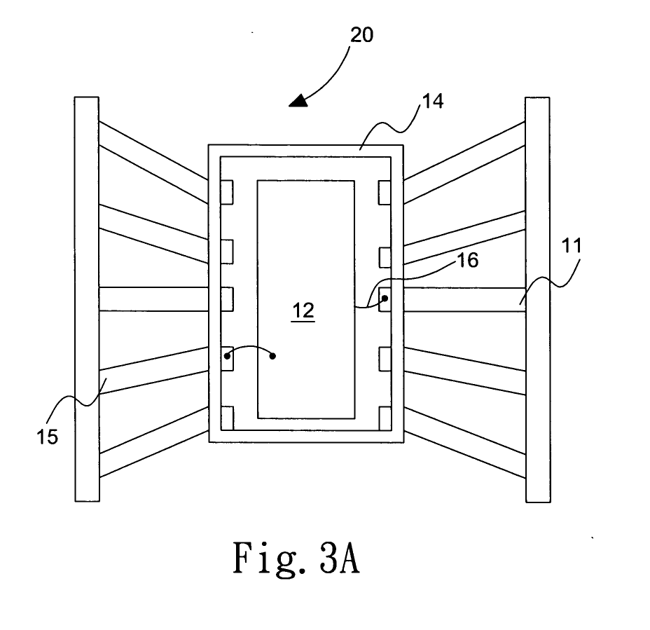

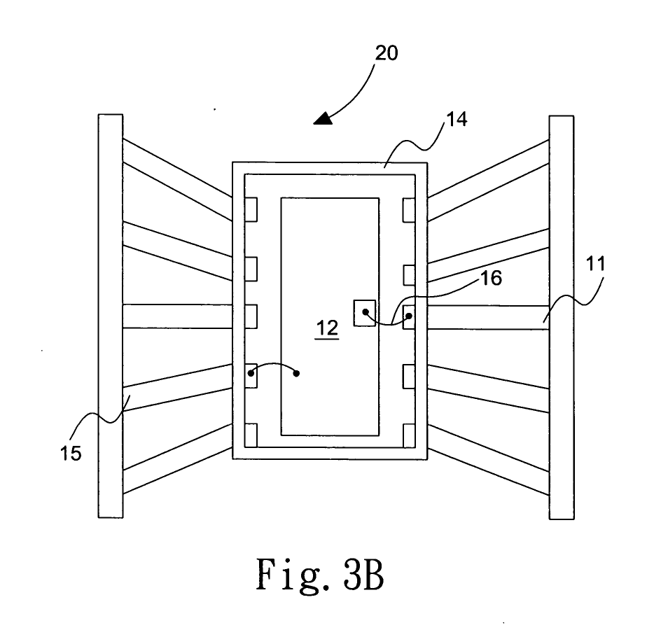

Refer to FIG. 3A and FIG. 3B diagrams schematically showing the package structure for a solar chip according to a second embodiment of the present invention. Similar to the dual In-line solar-chip package structure 10, the SMD (Surface Mount Device) solar-chip package structure 20 includes: a solar chip 12, a substrate 14, multitudes of wiring connection structures 16, and a covering. Different wiring connection structures 16 are respectively connected to the positive electrode and the negative electrode, which are simultaneously disposed at same side of the solar chip 12 or separately disposed at different sides of the solar chip 12. Dissimilar to the dual In-line solar-chip package structure 10, the SMD solar-chip package structure 20 has external leads 11 and 15 extending from the lateral sides of the solar chip 12. Therefore, the SMD solar-chip package structure 20 has a flattened geometry. Thus, the contact points of the external leads 11 and 15 may be affixed to an external element via an SMT method. Besides, the covering of the SMD solar-chip package structure 20 may be made of an anti-reflective transparent material to increase incident sunlight.

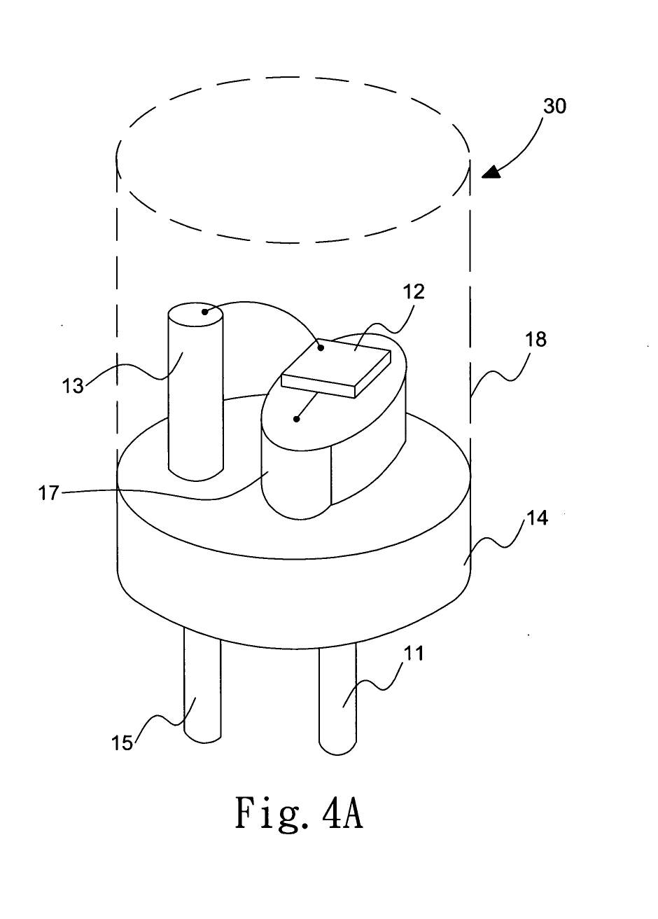

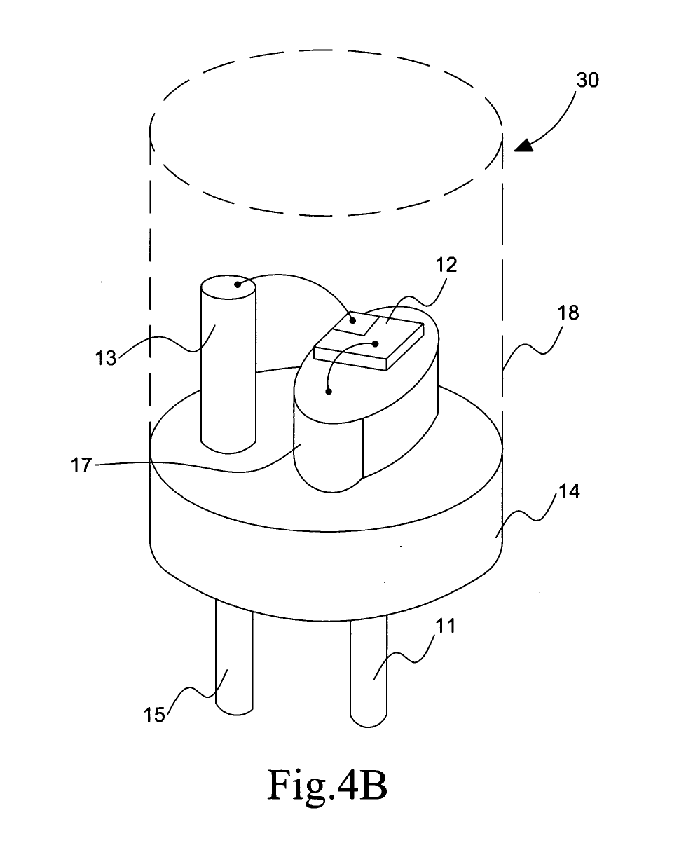

Refer to FIG. 4A and FIG. 4B diagrams schematically showing the package structure for a solar chip according to a third embodiment of the present invention. The TO (Transistor Outline)-Cans solar-chip package structure 30 includes: a solar chip 12, a TO header 14, a TO body 18. In this embodiment, the solar chip 12 is affixed to the TO header 14 and electrically coupled to the inner lead 13 and the contact 17 on the TO header 14. The inner lead 13 and the contact 17 may penetrate the TO header 14 and extend outward to function as external leads 15 and 11. The TO body 18 may protect the solar chip 12 and focus the sunlight coming from all directions, and the TO body 18 may be made of an anti-reflective material so that more sunlight may penetrate the TO body 18. The shape of the TO body 18 is not limited to be the column shape shown FIG. 4A and FIG. 4B but may further include all shapes having light-focusing effect. Besides, what is installed on the TO header 14 is not limited to one or multitudes solar chips 12 but may also include chips and elements of other functions.

Those embodiments described above are to clarify the technical thoughts and characteristics of the present invention in order to enable the persons skilled in the art to understand, make and use the present invention. However, it is not intended to limit the scope of the present invention, and any equivalent modification and variation according to the spirit of the present invention is to be also included within the scope of the claims of the present invention.

What is claimed is:

1. A light-focusing package structure for a solar chip, comprising:
a solar chip;
a substrate supporting said solar chip;
a plurality of wiring connection structures electrically coupled to said solar chip; and
a covering encapsulating said solar chip, said substrate, and said wiring connection structures, focusing sunlight, and comprising an anti-reflective structure to benefit sunlight absorption.

2. The light-focusing package structure for a solar chip according to claim 1, wherein said covering is formed via a plastic injection-molding process.

3. The light-focusing package structure for a solar chip according to claim 1, wherein said covering is formed via a mold-filling process.

4. The light-focusing package structure for a solar chip according to claim 1, wherein said covering is formed via filling epoxy into a mold.

5. The light-focusing package structure for a solar chip according to claim 1, which includes a package structure with leads.

6. The light-focusing package structure for a solar chip according to claim 1, which includes a dual In-Line package structure.

7. The light-focusing package structure for a solar chip according to claim 1, which includes a surface mount device package structure.

8. The light-focusing package structure for a solar chip according to claim 1, comprising a Transistor Outline-Cans package structure.

9. The light-focusing package structure for a solar chip according to claim 1, wherein said wiring connection structures further comprise a plurality of power leads penetrating through and extending outward from said covering.

10. The light-focusing package structure for a solar chip according to claim 1, wherein said covering is a transparent cap.

11. The light-focusing package structure for a solar chip according to claim 1, wherein said covering is a hollow pipe.

12. The light-focusing package structure for a solar chip according to claim 1, wherein said solar chip is a mono-crystalline-silicon solar chip.

13. The light-focusing package structure for a solar chip according to claim 1, wherein said solar chip is a polycrystalline-silicon solar chip.

14. The light-focusing package structure for a solar chip according to claim 1, wherein said solar chip is an amorphous-silicon solar chip.

15. The light-focusing package structure for a solar chip according to claim 1, wherein said solar chip is a compound solar chip.

16. The light-focusing package structure for a solar chip according to claim 1, wherein said solar chip absorbs sunlight.

17. The light-focusing package structure for a solar chip according to claim 1, wherein the positive electrode and the negative electrode of said solar chip are simultaneously disposed at same side of said solar chip.

18. The light-focusing package structure for a solar chip according to claim 1, wherein the positive electrode and the negative electrode of said solar chip are respectively disposed at different sides of said solar chip.

19. The light-focusing package structure for a solar chip according to claim 1, wherein the leads of said package structure are assembled into an array.

20. The light-focusing package structure for a solar chip according to claim 1, wherein said covering is suitable for an array-type assembled into an array.
